(19) United States
(12) Patent Application Publication
(10) Pub. No.: US 2017/0372705 A1
(43) Pub. Date: Dec. 28, 2017

(54) METHOD AND APPARATUS FOR INTERACTION BETWEEN ROBOT AND USER

(71) Applicant: Qihan Technology Co., Ltd., Shenzhen (CN)

(72) Inventors: Lvde Lin, Shenzhen (CN); Yongjun Zhuang, Shenzhen (CN)

(21) Appl. No.: 15/239,881

(22) Filed: Aug. 18, 2016

(30) Foreign Application Priority Data
Jun. 27, 2016 (CN) 201610480936.8

(51) Int. Cl. G10L 17/22; B25J 11/00; B25J 9/00; G10L 25/48; G06K 9/00

(52) U.S. Cl. CPC G10L 17/22; G10L 25/48; G06K 9/00288; B25J 9/0003; B25J 11/0005; G06K 9/00228

(57) ABSTRACT

The present invention is applied to the human-robot interaction field, and provides a method and an apparatus for interaction between a robot and a user; the method includes: determining an original direction where a voice signal is generated upon receiving a voice signal; adjusting a robot from a current direction to the original direction, and capturing a picture corresponding to the original direction; detecting whether a human face exists in the picture; when a human face exists in the picture, recognizing whether a user corresponding to the human face is a legal user; and when the user corresponding to the human face is a legal user, interacting with the legal user. The method can improve the accuracy of instruction execution of the robot.

### FIELD OF THE INVENTION

The present invention belongs to the field of human-robot interaction, especially relates to a method and an apparatus for interaction between a robot and a user.

### BACKGROUND

A robot is a mechanical apparatus capable of performing work automatically, it can not only accept human instructions but also run pre-programmed procedures, and can also act in accordance with principles and programs established by an artificial intelligence technology.

When an existing robot detects a voice signal of a user, the robot estimates the user's location and direction according to a sound source positioning technology; and when receiving an instruction of going forward sent by the user, the robot controls itself to rotate towards the estimated location and direction. However, since the user sending the instruction may not be the owner of the robot, the robot may execute an instruction that is not sent by its owner and result in an instruction execution error.

### BRIEF DESCRIPTION

Embodiments of the present invention provide a method and an apparatus for interaction between a robot and a user, which aims to solve the problem that an existing robot only performs actions based on received instructions, and may execute an instruction which is not sent by its owner, which results in problems of instruction execution errors.

The invention is realized as follows. A method for interaction between a robot and a user; the method comprises:

determining an original direction where a voice signal is generated upon receiving a voice signal;

adjusting a robot from a current direction to the original direction, and capturing a picture corresponding to the original direction;

detecting whether a human face exists in the picture;

when a human face exists in the picture, recognizing whether a user corresponding to the human face is a legal user; and when the user corresponding to the human face is a legal user, interacting with the legal user.

Another purpose of the embodiments of the invention is to provide an apparatus for interaction between a robot and a user; the apparatus comprises:

a voice signal receiving unit configured to determine an original direction where the voice signal is generated upon receiving a voice signal;

a picture capturing unit configured to adjust the robot from a current direction to the original direction, and capture a picture corresponding to the original direction;

a human face detecting unit configured to detect whether a human face exists in the picture;

a legal user judging unit configured to recognize whether the user corresponding to the human face is a legal user when a human face exists in the picture;

a human-robot interaction unit configured to interact with the legal user when the user corresponding to the human face is a legal user.

In the embodiments of the invention, since the robot interacts with the legal user only when the user corresponding to the human face is judged as being a legal user, it can be ensured that all the instructions executed by the robot are sent out by its owner, and thus the accuracy of the execution for the instructions is improved.

### BRIEF DESCRIPTION OF THE DRAWINGS

FIG. 1 is a flow chart of a method for interaction between a human and a user provided by a first embodiment of the present invention;

FIG. 2 is a schematic view of determining a corresponding specific location where a voice signal is generated provided by the first embodiment of the present invention;

FIG. 3 is schematic view of determining a required adjustment angle according to a location of a captured human face in a captured picture provided by the first embodiment of the present invention; and

FIG. 4 shows an apparatus for interaction between a human and a user provided by a second embodiment of the present invention.

### DETAILED DESCRIPTION

In order to make the purposes, technical solutions and advantages of the present invention more clear, the invention will be further described in detail with reference to the drawings and the embodiments. It is to be understood that the specific embodiments described herein are merely intended to explain the present invention but not to limit the present invention.

In an embodiment of the present invention, determining a corresponding original direction where the voice signal is generated upon receiving a voice signal; adjusting the robot from the current direction to the original direction, and capturing a picture corresponded to the original direction, detecting whether a human face exists in the picture or not; when a human face exists in the picture, recognizing whether a user corresponding to the human face is a legal user; when the user corresponding to the human face is a legal user, interacting with the legal user.

In order to illustrate the schemes of the present invention, specific embodiments are described as follows:

### The First Embodiment

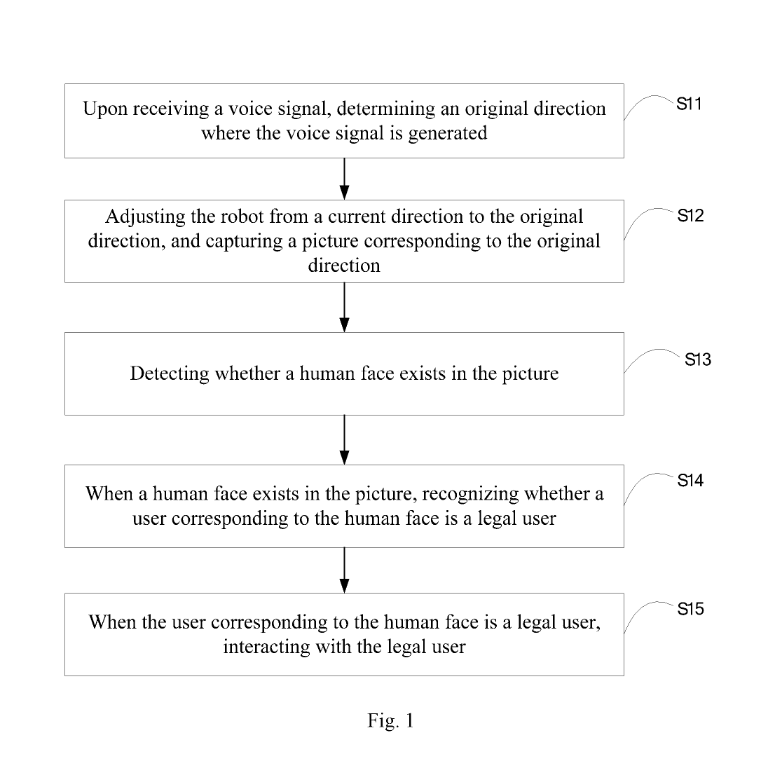

FIG. 1 illustrates a flow chart of a human-robot interactive method provided by the first embodiment of the present invention; details of the first embodiment are as follows:

Step 11. Upon receiving a voice signal, determining an original direction where the voice signal is generated.

In this step, after receiving the voice signal, the robot estimates the original direction corresponding to the voice signal according to a sound source positioning technology. For example, when receiving a plurality of voice signals, the robot estimates the original direction corresponding to the strongest voice signal according to the positioning technology.

Optionally, in order to avoid interference and save electricity, the step 11 specifically includes:

A1. Judging whether the voice signal is a wakeup instruction or not upon receiving the voice signal. Specifically, identifying the meaning of words and sentences contained in the voice signal; if the meaning of the words and sentences contained in the voice signal is identical with predefined meaning, the voice signal is determined to be a wakeup instruction; otherwise, the voice signal is determined not to be a wakeup instruction. Furthermore, when the meaning of the words and sentences contained in the voice signal is identical with the predefined meaning, further judging whether a frequency and/or tone of the voice signal is identical with a predefined frequency and/or tone; if identical, the voice signal is determined to be a wakeup instruction.

A2. When the voice signal is a wakeup instruction, determining the original direction where the voice signal is generated.

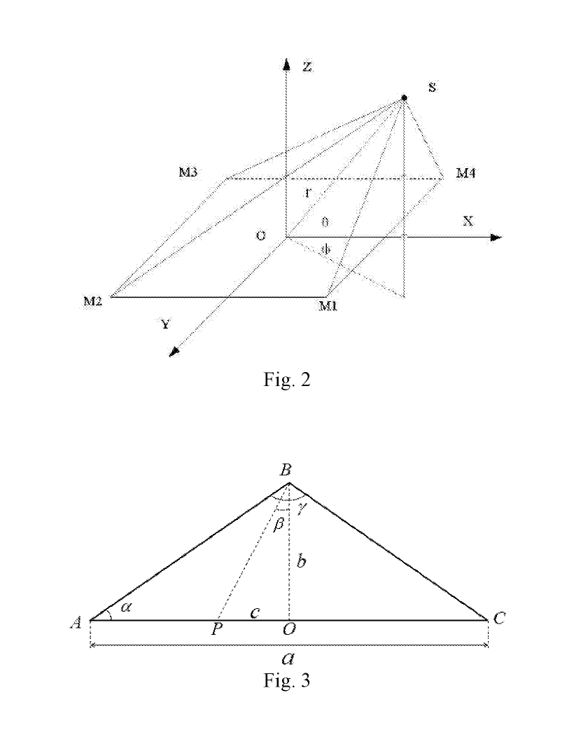

Specifically, the original direction corresponding to the voice signal can be estimated through the sound source positioning technology. Surly, if the specific location where the voice signal is generated requires being determined, it can be determined by a time difference between received voice signals. For example, the robot is provided thereon with four microphones; an array of the four microphones is a four-element cross array, and the four microphones are arranged in the same plane in a cross shape, wherein S denotes the location of voice source; M1, M2, M3, M4 respectively denote locations of four elements (i.e., the microphones) in the four-element cross array, as shown in FIG. 2. Wherein, a target azimuth angle is φ, a sound source elevation angle is θ (i.e., an angle constituted by \vec{OS} and \vec{OX}); r is a distance between the target voice source (i.e., S) and the ordinate origin O; a time difference between voices received by two microphones Mᵢ and Mⱼ is denoted by tᵢⱼ. Thus, the original direction and location where the voice signal is generated can be determined by the following equation:

$$\{ \begin{matrix}tan φ = \frac{{t}_{41} + {t}_{31} - {t}_{21}}{{t}_{21} + {t}_{31} - {t}_{41}} \\ cos θ = \frac{C}{L} \sqrt{\frac{{t}_{31}^{2} + {( {t}_{41} - {t}_{21} )}^{2}}{2}} \\ r = \frac{c [ {t}_{31}^{2} + {( {t}_{41} - {t}_{21} )}^{2} ]}{4 ( {t}_{41} - {t}_{31} + {t}_{21} )}\end{matrix} ,$$

Step 12. Adjusting the robot from a current direction to the original direction, and capturing a picture corresponding to the original direction.

After determining the original direction, if the current direction of the robot is not identical with the original direction, the robot is adjusted from the current direction to the original direction, and the picture corresponding to the direction is captured by a picture capturing apparatus such as a camera, a high-definition colored vidicon and so on; the picture can be a 2D picture or a 3D picture.

Step 13. Detecting whether a human face exists in the picture.

Specifically, the robot detects whether a human face exists in the picture by a face detection algorithm.

Step 14. When a human face exists in the picture, recognizing whether a user corresponding to the human face is a legal user.

Optionally, the step 14 specifically includes:

B1. Capturing a voice signal and/or a picture of the user corresponding to the human face. In this step, the voice signal of the user corresponding to the captured human face can be a voice signal corresponding to the original direction or a voice signal obtained by warning the user to make a voice again. Similarly, the picture of the user corresponding to the captured human face can be a picture of the user captured in the original direction by the robot or a picture of the human face obtained by shooting the picture of the human face again.

B2. When the voice signal and/or the picture of the user corresponding to the human face is identical to a predefined voice signal and/or a predefined picture, determining that the user corresponding to the human face is a legal user, otherwise, determining that the user corresponding to the human face is an illegal user. Specifically, by predefining one or more voice signals and/or predefining one or more pictures, when the captured voice signals and/or pictures are identical with the predefined voice signals and/or pictures, determining that the user corresponding to the human face is a legal user. Surly, whether two voice signals are identical or not can be determined by judging whether frequencies and/or tones of the voice signals are identical.

Optionally, in order to make the interaction between the robot and the user be more natural and more realistic, a certain angle can be adjusted such that the robot communicates with the user face in face and thus the intellectuality of human-robot interaction is improved. When the user corresponding to the human face is a legal user, the method further includes:

determining a required adjustment angle according to the location of the human face in the picture; and adjusting the robot correspondingly according to the required adjustment angle.

Specifically, first of all, the human face of which the location in the picture should be the basis for determining the required adjustment angle is determined: judging whether the number of the human face is more than one; when the number is more than one, choosing the face with the least depth, and determining the required adjustment angle according to the location of the human face with the least depth in the picture. When the number is one, determining the required adjustment angle according to the location of the human face in the picture. The less the depth is, the shorter the distance between the human and the robot is; and the shorter the distance between a user and a robot is, the greater the possibility that the user is the owner of the robot. Therefore, the required adjustment angle determined according to the depth of the human face is more precise. Since when only one human face exists in the picture, the human face normally belongs to the owner of the robot, the required adjustment angle can be determined only according to the location of the human face in the picture.

Furthermore, the required adjustment angle is determined:

determining a distance c between the human face and a central point of the picture; and determining a width a of the picture;

according to the equation:

$$\{ \begin{matrix}tan α = \frac{2 b}{a} \\ tan β = \frac{c}{b} \\ α = \frac{1}{2} ( π - γ )\end{matrix} ,$$

determining the required adjustment angle:

$$β = arctan \frac{2 c / a}{tan \frac{π - γ}{2}} ;$$

Wherein, α is the angle between the plane where the picture lies and the line connecting the robot with a left or right side of the picture; b is the distance between the robot and the central point of the picture; β is the required adjustment angle; γ is a visual angle of the robot.

As shown in FIG. 3, B is the location of the face of the robot; P is the location of the user's face; γ is the visual angle of the robot; OP represents the distance between the human face and the central point of the picture, the length thereof being denoted by c. After the robot captures a picture, the robot can determine the values of c and a, and then obtain the angle β between the face of the robot and the user's face according to the above equation. In FIG. 3, the robot should rotate by a degree of β rightward so as to ensure that the robot and the user are face to face. Surly, if P is located between O and C, then the robot is required to be rotated by β degrees leftward.

Step 15. When the user corresponding to the human face is a legal user, interacting with the legal user.

In the step, only interacting with the legal user can save the energy of the robot, protect the robot from being manipulated by an illegal user, and thereby improve the security of the robot.

In order to further improve the security of the robot, when the user corresponding to the human face is an illegal user, a picture of the human face of the illegal user is captured, and the captured picture of the human face of the illegal user is transmitted to a designated user, for example, a mobile terminal of a designated user. Furthermore, when the picture of the human face of the illegal user is transmitted to the designated user, a waning is sent to warn the user to check in time. Normally, the designated user is a legal user. Since the picture of the human face of the illegal user is sent to the designated user (such as the owner of the robot), the designated user can be informed in time that an illegal user is trying to manipulate the robot and is capable of stopping the action of the illegal user in time.

In the first embodiment of the invention, determining a corresponding original direction where the voice signal is generated upon receiving a voice signal; adjusting the robot from a current direction to the original direction, and capturing a picture corresponding to the original direction; detecting whether a human face exists in the picture; when a human face exists in the picture, recognizing whether the user corresponding to the human face is a legal user; interacting with the legal user when the user corresponding to the human face is a legal user. Only when the user corresponding to the human face is judged as being a legal user, the robot interacts with the legal user; therefore, it can be ensured that all the instructions executed by the robot are sent by its owner, and thus the accuracy of the execution for the instructions is improved.

It should be understood that in the embodiments of the present invention, the sequence numbers of the above processes do not mean the execution sequence; the execution sequence of each process should be determined by functions and internal logics thereof, and should not form any limitation to the execution processes of the embodiments of the present invention.

### The Second Embodiment

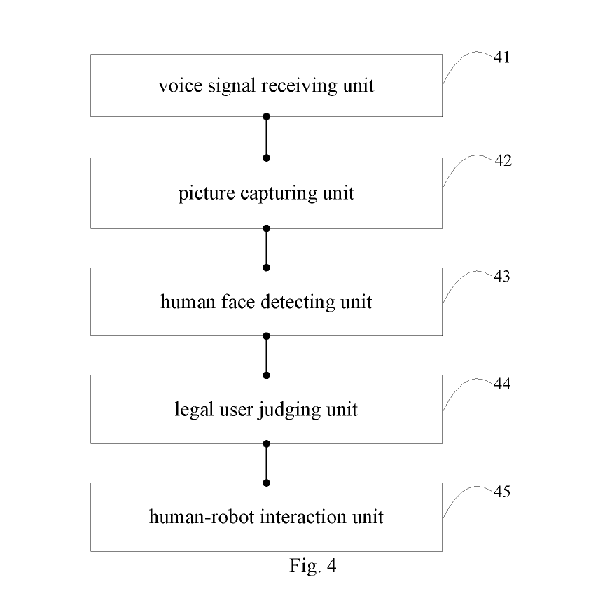

FIG. 4 illustrates a structure diagram of an apparatus for interaction between a robot and a user provided by the second embodiment of the invention. The apparatus for interaction between a robot and a user can be applied to a variety of robots. For clarity, only the portions relevant to the embodiment of the present invention are shown.

The apparatus for adjusting an interactive direction of a robot includes a voice signal receiving unit 41, a picture capturing unit 42, a human face detecting unit 43, a legal user judging unit 44 and a human-robot interaction unit 45. Wherein:

The voice signal receiving unit 41 is configured to determine a corresponding original direction where the voice signal is generated upon receiving a voice signal.

Specifically, after receiving the voice signal, the robot estimates the original direction corresponding to the voice signal by utilizing sound source positioning technology. For example, when receiving multiple voice signals, the robot estimates the original direction corresponded to the strongest voice signal by utilizing positioning technology.

Optionally, in order to avoid interference and save electricity, the voice signal receiving unit 41 specifically includes:

A wakeup instruction judging module configured to judge whether the voice signal is a wakeup instruction or not upon receiving the voice signal. Specifically, identifying the meaning of words and sentences contained in the voice signal; if the meaning of the words and sentences contained in the voice signal is identical with predefined meaning, the voice signal is determined to be a wakeup instruction; otherwise, the voice signal is determined not to be a wakeup instruction. Furthermore, when the meaning of the words and sentences contained in the voice signal is identical with the predefined meaning, further judging whether a frequency and/or tone of the voice signal is identical with a predefined frequency and/or tone; if identical, the voice signal is determined to be a wakeup instruction.

An original direction determining module configured to determine the original direction where the voice signal is generated when the voice signal is a wakeup instruction.

Specifically, the original direction corresponded to the voice signal can be estimated through the sound source positioning technology. Surly, if the specific location where the voice signal is generated is required to be determined, then a time difference of received voice signals can be utilized. For example, the robot is configured with four microphones thereon; an array of the four microphones is a four-element cross array, and the four microphones are arranged in the same plane in a cross shape, wherein S denotes the location of voice source; M1, M2, M3, M4 respectively denote locations of four elements (microphones) in the four-element cross array, as shown in FIG. 2. Wherein, a target azimuth angle is φ, and a sound source elevation angle is θ (angle constituted by \vec{OS} and \vec{OX}); γ is a distance between the target voice source (S) and the ordinate origin O; time difference of voices received by two microphones Mᵢ and Mⱼ is denoted by tᵢⱼ. Then, the original direction and location where the voice signal is generated can be determined by the following equation:

$$\{ \begin{matrix}tan φ = \frac{{t}_{41} + {t}_{31} - {t}_{21}}{{t}_{21} + {t}_{31} - {t}_{41}} \\ cos θ = \frac{C}{L} \sqrt{\frac{{t}_{31}^{2} + {( {t}_{41} - {t}_{21} )}^{2}}{2}} \\ r = \frac{c [ {t}_{31}^{2} + {( {t}_{41} - {t}_{21} )}^{2} ]}{4 ( {t}_{41} - {t}_{31} + {t}_{21} )}\end{matrix} ,$$

The picture capturing unit 42 is configured to adjust the robot from a current direction to the original direction, and capture a picture corresponded to the original direction.

After determining the original direction, if the current direction of the robot is not identical with the original direction, the robot is adjusted from the current direction to the original direction, and the picture corresponded to the direction is captured by utilizing a picture capturing apparatus such as a camera, a high-definition colored vidicon; the picture can be a 2D picture or a 3D picture.

The human face detecting unit 43 is configured to detect whether a human face exists in the picture.

The legal user judging unit 44 is configured to recognize whether the user corresponding to the human face is a legal user when a human face exists in the picture.

Optionally, the legal user judging unit 44 includes:

A user information capturing module configured to capture the voice signal and/or the picture of the user corresponding to the human face. Wherein, the voice signal of the user corresponding to the human face can be a voice signal corresponding to the original direction or a voice signal obtained by warning the user to make a voice again. Similarly, the picture of the user corresponding to the obtained human face can be a picture of the user captured in the original direction by the robot or a picture of a human face obtained by shooting the picture of the human face again.

A user legality determining module configured to determine that the user corresponding to the human face is a legal user when the voice signal and/or the picture of the user corresponding to the human face is identical to a predefined voice signal and/or a predefined picture, otherwise, determine that the user corresponding to the human face is an illegal user. Specifically, by predefining one or more voice signals and/or predefining one or more pictures, when the captured voice signals and/or pictures are identical with the predefined voice signals and/or pictures, the module determines that the user corresponding to the human face is a legal user. Surly, whether two voice signals are identical or not can be determined by judging whether frequencies and/or tones of the voice signals are identical.

Optionally, in order to make the interaction between the robot and the user be more natural and more realistic, a certain angle can be adjusted such that the robot communicates with the user face in face and the intellectuality of human-robot interaction is thereby improved. The apparatus for interaction between a robot and a user includes:

An adjustment angle determining unit configured to determine a required adjustment angle according to the location of the human face in the picture.

Specifically, the adjustment angle determining unit includes:

A picture information determining module configured to determine the distance c between the human face and a central point of the picture, and determine a width α of the picture.

An angle calculating module configured to determine the required adjustment angle:

$$β = arctan \frac{2 c / a}{tan \frac{π - γ}{2}}$$

according to the equation:

$$\{ \begin{matrix}tan α = \frac{2 b}{a} \\ tan β = \frac{c}{b} \\ α = \frac{1}{2} ( π - γ )\end{matrix} ,$$

Wherein, α is the angle between the plane of the picture and the line connecting the robot and the left or right side of the picture; b is the distance between the robot and the central point of the picture; β is the required adjustment angle; γ is the visual angle of the robot.

Furthermore, before determining the required adjustment angle, the adjustment angle determining unit is configured to determine the human face of which the location in the picture should be the basis for determining the required adjustment angle. Specifically, the adjustment angle determining unit judges whether the number of the human face is more than one; when the number is more than one, the face with the least depth is chosen, and the required adjustment angle is determined according to the location of the human face with the least depth in the picture. When the number is one, the required adjustment angle is determined according to the location of the human face in the picture.

The human-robot interaction unit 45 is configured to interact with the legal user when the user corresponding to the human face is a legal user.

In order to further improve the security of the robot, the apparatus for interaction between a robot and a user includes:

An illegal user picture capturing unit configured to capture the picture of the human face of the illegal user when a user corresponding to the human face is an illegal user, and transmit the picture to a designated user. Furthermore, when the picture of the human face of the illegal user is transmitted to the user, the illegal user picture capturing unit sends out a warning to warn the user to check in time. Normally, the designated user is a legal user. Since the picture of the human face of the illegal user is sent to the designated user (such as to the owner of the robot), the designated user can be informed that an illegal user is trying to manipulate the robot in time and is capable of stopping the actions raised by the illegal user in time.

In the second embodiment of the invention, only when the user corresponding to the human face is judged as being a legal user, the robot interacts with the legal user; therefore, it can be ensured that all the instructions executed by the robot are sent by its owner, and thus the accuracy of the execution for the instructions is improved.

Those skilled in the art should understand that the exemplary units and algorithm steps described in accompany with the embodiments disclosed in the specification can be achieved by electronic hardware, or the combination of computer software with electronic hardware. Whether these functions are executed in a hardware manner or a software manner depends on the specific applications and design constraint conditions of the technical solutions. With respect to each specific application, a professional technician can achieve the described functions utilizing different methods, and these achievements should not be deemed as going beyond the scope of the invention.

It can be clearly understood for those skilled in the art that for convenience and concision of the description, the specific operation processes of the above-described systems, apparatuses and units can make reference to the correspondence processes in the above mentioned method embodiments, and are not repeated here.

It should be understood that the systems, apparatuses and methods disclosed in some embodiments provided by the present application can also be realized in other ways. For example, the described apparatus embodiments are merely schematic; for example, the division of the units is merely a division based on logic function, whereas the units can be divided in other ways in actual realization; for example, a plurality of units or components can be grouped or integrated into another system, or some features can be omitted or not executed. Furthermore, the shown or discussed mutual coupling or direct coupling or communication connection can be achieved by indirect coupling or communication connection of some interfaces, apparatuses or units in electric, mechanical or other ways.

The units described as isolated elements can be or not be separated physically; an element shown as a unit can be or not be physical unit, which means that the element can be located in one location or distributed at multiple network units. Some or all of the units can be selected according to actual needs to achieve the purpose of the schemes of the embodiments.

Furthermore, each functional unit in each embodiment of the present invention can be integrated into a processing unit, or each unit can exist in isolation, or two or more than two units can be integrated into one unit. The integrated unit can be achieved in hardware or in software function unit.

If the integrated unit is achieved in software functional unit and sold or used as an independent product, the integrated unit can be stored in a computer-readable storage medium. Based on this consideration, the substantial part, or the part that is contributed to the prior art of the technical solution of the present invention, or part or all of the technical solutions can be embodied in a software product. The computer software product is stored in a storage medium, and includes several instructions configured to enable a computer device (can be a personal computer, device, network device, and so on) to execute all or some of the steps of the method of each embodiment of the present invention. The storage medium includes a U disk, a mobile hard disk, a read-only memory (ROM, Read-Only Memory), a random access memory (RAM, Random Access Memory), a disk or a light disk, and other various mediums which can store program codes.

The above contents merely describe specific embodiments of the present invention, which are not intended for limiting the protection scope of the present invention; anyone ordinarily skilled in the art can readily envisage modifications and equivalents to the technical solutions without departing from the scope disclosed by the present invention, which should be within the protection scope of the invention. Therefore, the protection scope of the present invention should be based on the claims.

1. A method for interaction between a robot and a user, wherein the method comprises:
determining an original direction where a voice signal is generated upon receiving a voice signal;
adjusting a robot from a current direction to the original direction, and capturing a picture corresponding to the original direction;
detecting whether a human face exists in the picture;
when a human face exists in the picture, recognizing whether a user corresponding to the human face is a legal user; and
when the user corresponding to the human face is a legal user, interacting with the legal user.

2. The method of claim 1, wherein the step of recognizing whether a user corresponding to the human face is a legal user comprises:
capturing a voice signal and/or a picture of the user corresponding to the human face;
when the voice signal and/or the picture of the user corresponding to the human face is identical to a predefined voice signal and/or a predefined picture, determining that the user corresponding to the human face is a legal user, otherwise, determining that the user corresponding to the human face is an illegal user.

3. The method of claim 1, wherein when a user corresponding to the human face is a legal user, the method further comprises:
determining a required adjustment angle according to a location of the human face in the picture;
adjusting the robot correspondingly according to the required adjustment angle.

4. The method of claim 3, wherein the step of determining a required adjustment angle according to the location of the human face in the picture includes:
determining a distance c between the human face and a central point of the picture; determining a width a of the picture;
according to equation:
$$\{ \begin{matrix}tan α = \frac{2 b}{a} \\ tan β = \frac{c}{b} \\ α = \frac{1}{2} ( π - γ )\end{matrix} ,$$
determining a required adjustment angle:
$$β = arctan \frac{2 c / a}{tan \frac{π - γ}{2}} ;$$
Wherein, α is an angle between a plane where the picture lies and a line connecting the robot with a left or right side of the picture; b is a distance between the robot and a central point of the picture; β is the required adjustment angle; γ is a visual angle of the robot.

5. The method of claim 1, wherein when the user corresponding to the human face is an illegal user, capturing the picture of the human face of the illegal user and transmitting the picture of the human face of the illegal user to a designated user.

6. The method of claim 2, wherein when the user corresponding to the human face is an illegal user, capturing the picture of the human face of the illegal user and transmitting the picture of the human face of the illegal user to a designated user.

7. The method of claim 3, wherein when the user corresponding to the human face is an illegal user, capturing the picture of the human face of the illegal user and transmitting the picture of the human face of the illegal user to a designated user.

8. The method of claim 4, wherein when the user corresponding to the human face is an illegal user, capturing the picture of the human face of the illegal user and transmitting the picture of the human face of the illegal user to a designated user.

9. An apparatus for interaction between a robot and a user, wherein the apparatus comprises:
a voice signal receiving unit configured to determine an original direction where the voice signal is generated upon receiving a voice signal;
a picture capturing unit configured to adjust the robot from a current direction to the original direction, and capture a picture corresponding to the original direction;
a human face detecting unit configured to detect whether a human face exists in the picture;
a legal user judging unit configured to recognize whether the user corresponding to the human face is a legal user when a human face exists in the picture;
a human-robot interaction unit configured to interact with the legal user when the user corresponding to the human face is a legal user.

10. The apparatus of claim 9, wherein the legal user judging unit comprises:
a user information capturing module configured to capture the voice signal and/or a picture of the user corresponding to the human face;
a user legality determining module configured to determine that the user corresponding to the human face is a legal user when the voice signal and/or the picture of the user corresponding to the human face is identical to a predefined voice signal and/or a predefined picture, otherwise, determine that the user corresponding to the human face is an illegal user.

11. The apparatus of claim 9, wherein the apparatus comprises:
an adjustment angle determining unit configured to determine a required adjustment angle according to a location of the human face in the picture.

12. The apparatus of claim 11, wherein the adjustment angle determining unit comprises:
a picture information determining module configured to determine a distance c between the human face and a central point of the picture, and determine a width a of the picture;
an angle calculating module configured to determine the required adjustment angle:
$$β = arctan \frac{2 c / a}{tan \frac{π - γ}{2}}$$
according to equation:
$$\{ \begin{matrix}tan α = \frac{2 b}{a} \\ tan β = \frac{c}{b} \\ α = \frac{1}{2} ( π - γ )\end{matrix} ,$$
wherein, α is an angle between a plane of the picture and a line connecting the robot and left or right side of the picture; b is a distance between the robot and a central point of the picture; β is the required adjustment angle; γ is a visual angle of the robot.

13. The apparatus of claim 9, wherein the apparatus comprises:
an illegal user picture capturing unit configured to capture the picture of the human face of the illegal user when a user corresponding to the human face is an illegal user, and transmit the picture of the human face of the illegal user to a designated user.

14. The apparatus of claim 10, wherein the apparatus comprises:
an illegal user picture capturing unit configured to capture the picture of the human face of the illegal user when a user corresponding to the human face is an illegal user, and transmit the picture of the human face of the illegal user to a designated user.

15. The apparatus of claim 11, wherein the apparatus comprises:
an illegal user picture capturing unit configured to capture the picture of the human face of the illegal user when a user corresponding to the human face is an illegal user, and transmit the picture of the human face of the illegal user to a designated user.

16. The apparatus of claim 12, wherein the apparatus comprises:
an illegal user picture capturing unit configured to capture the picture of the human face of the illegal user when a user corresponding to the human face is an illegal user, and transmit the picture of the human face of the illegal user to a designated user.
